(19) United States
(12) Patent Application Publication
(10) Pub. No.: US 2017/0188646 A1
(43) Pub. Date: Jul. 6, 2017

(54) HELMET CHIN GUARD

(71) Applicant: JARVISH INC., Taipei City (TW)

(72) Inventor: Younger Liang, Neihu District, Taipei City (TW)

(21) Appl. No.: 15/250,884

(22) Filed: Aug. 29, 2016

(30) Foreign Application Priority Data
Jan. 4, 2016 (TW) 105200046

(51) Int. Cl. A42B 3/04; A42B 3/22; G02B 27/01; G06F 3/16; G09G 3/00; A42B 3/20; A42B 3/30

(52) U.S. Cl. CPC A42B 3/042; A42B 3/205; A42B 3/225; A42B 3/303; G06F 3/16; G09G 3/002; G02B 27/0176; G02B 27/0172; G02B 2027/0138; G02B 2027/014; G02B 2027/0169

(57) ABSTRACT

A helmet chin guard is applicable to a helmet with a visor. The chin guard includes a main body, a mini projection unit and a control unit. The main body has multiple connection sections detachably connected with the helmet. The mini projection unit serves to receive video information output from the control unit and project the video information onto the visor. By means of the helmet chin guard, a rider can watch the video information on the visor to enhance safety in riding.

This application claims the priority benefit of Taiwan patent application number 105200046 filed on Jan. 4, 2016.

### BACKGROUND OF THE INVENTION

1. Field of the Invention

The present invention relates generally to a helmet chin guard, and more particularly to a chin guard applicable to an open-face helmet to enhance safety in riding.

2. Description of the Related Art

It is regulated in traffic regulations that when riding power machinery (motorcycle), a rider must wear a helmet. There are various helmets on the current market. The most important function of the helmet is to protect a rider's head and neck from getting hurt. An ordinary helmet lacks any additional function.

Some manufacturers add a mini projection unit and other electronic components to the conventional helmet. Accordingly, when riding a motorcycle, a rider can watch such as, but not limited to, the video recorded by the dashboard camera or the navigation information so as to enhance safety in riding.

However, in order to use the helmet with the additional mini projection unit and the other electronic components, the rider often discards the currently used helmet. This not only will increase the environmental burden, but also will increase the unnecessary riding cost of the rider.

It is therefore tried by the applicant to provide a chin guard applicable to a conventional open-face helmet to enhance safety in riding. A rider can use the additional electronic functions of the chin guard without discarding the currently used helmet. Therefore, the additional environmental burden is avoided and the riding cost will not be increased.

### SUMMARY OF THE INVENTION

It is therefore a primary object of the present invention to provide a helmet chin guard capable of enhancing safety in riding.

It is a further object of the present invention to provide the above helmet chin guard, which can reduce additional environmental burden and lower riding cost.

To achieve the above and other objects, the helmet chin guard of the present invention is applicable to a helmet with a visor. The chin guard includes a main body, a mini projection unit and a control unit. The main body has multiple connection sections respectively disposed on two opposite sides of the main body. The connection sections are detachably connected with the helmet. The mini projection unit is disposed on one side of the main body. The mini projection unit serves to receive and project video information onto the visor. The control unit is disposed in the main body and connected to the mini projection unit. The control unit serves to output and transmit the video information to the mini projection unit.

In the above helmet chin guard, the helmet has multiple connected sections corresponding to the connection sections. The connected sections are detachably connected with the connection sections.

The helmet chin guard further includes at least one sensation unit. The sensation unit is connected to the control unit and disposed in the main body for generating and transmitting at least one sensation signal to the control unit.

The helmet chin guard further includes at least one wireless transmission unit. The wireless transmission unit is connected to the control unit and disposed in the main body for wirelessly connecting to a corresponding external device. The external device can be a computer, an intelligent mobile device, a notebook, an intelligent helmet or another chin guard.

The helmet chin guard further includes a pickup unit. The pickup unit is connected to the control unit and disposed in the main body in alignment with a user's mouth. The pickup unit serves to receive a first audio signal and transmit the first audio signal to the control unit.

The helmet chin guard further includes a speaker unit. The speaker unit is connected to the control unit and disposed in the main body in alignment with a user's ear for outputting a second audio signal.

The helmet chin guard further includes a distance sensation unit. The distance sensation unit is connected to the control unit and disposed on a front side of the main body for generating and transmitting a distance sensation signal to the control unit.

The helmet chin guard further includes a camera unit. The camera unit is connected to the control unit and disposed on the front side of the main body for capturing environmental video information and transmitting the environmental video information to the control unit.

The helmet chin guard further includes a storage unit. The storage unit is connected to the control unit and disposed in the main body for the control unit to store or access environmental video information.

The helmet chin guard further includes a wired transmission unit. The wired transmission unit is connected to the control unit and disposed on the main body to be wiredly connected to a corresponding external device. The external device can be a computer, an intelligent mobile device, a notebook, an intelligent helmet or another chin guard.

The helmet chin guard further includes a power supply unit. The power supply unit is connected to the control unit and disposed in the main body for supplying power to the control unit.

The helmet chin guard further includes at least one pushbutton. The pushbutton is connected to the control unit and disposed on the main body for transmitting at least one set state signal to the control unit.

The helmet chin guard further includes a display unit. The display unit is connected to the control unit and disposed on the main body. The display unit serves to receive a control signal from the control unit to display at least one state information.

The helmet chin guard further includes a vibration unit. The vibration unit is connected to the control unit and disposed in the main body to co-vibrate with the main body.

The helmet chin guard further includes a positioning unit. The positioning unit is connected to the control unit and disposed in the main body for generating and transmitting positioning information to the control unit.

By means of the helmet chin guard of the present invention, the safety in riding is enhanced. Moreover, a rider can use the additional electronic functions of the helmet chin guard without discarding the currently used helmet. Therefore, the additional environmental burden is avoided and the riding cost will not be increased.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a preferred embodiment of the present invention;

FIG. 2 is a perspective view showing that the preferred embodiment of the chin guard of the present invention is connected with an open-face helmet; and

FIG. 3 is a block diagram of the preferred embodiment of the present invention.

### DETAILED DESCRIPTION OF THE PREFERRED EMBODIMENTS

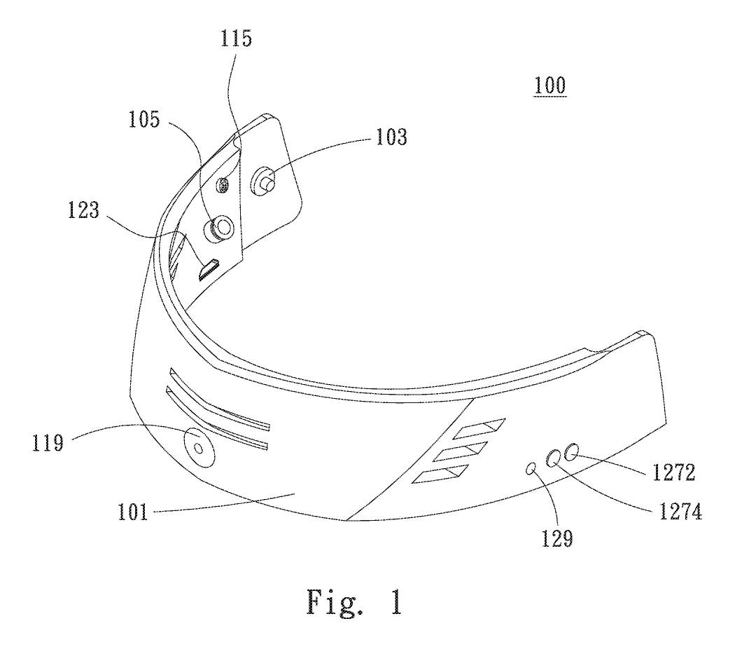

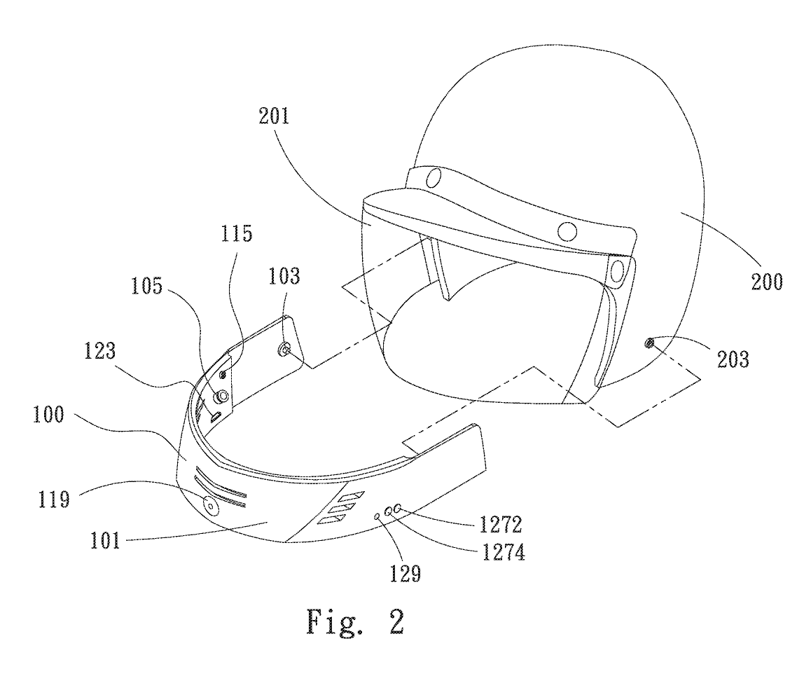

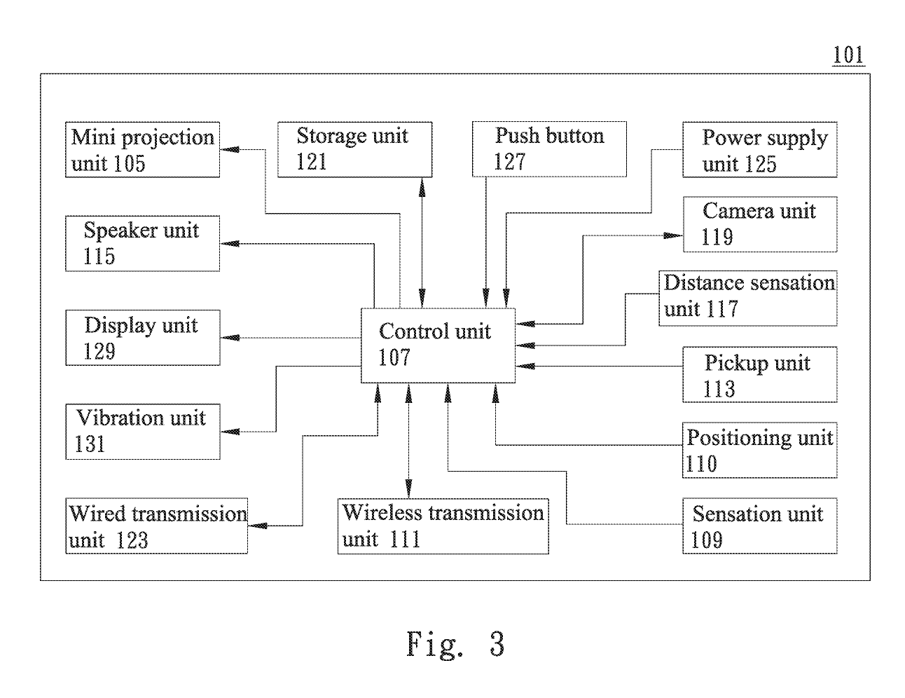

Please refer to FIGS. 1 to 3. FIG. 1 is a perspective view of a preferred embodiment of the present invention. FIG. 2 is a perspective view showing that the preferred embodiment of the chin guard of the present invention is connected with an open-face helmet. FIG. 3 is a block diagram of the preferred embodiment of the present invention. According to the preferred embodiment, the helmet chin guard 100 of the present invention is applicable to a helmet 200 with a visor 201. The chin guard 100 includes a main body 101, a mini projection unit 105 and a control unit 107. In this embodiment, the helmet 200 is, but not limited to, an open-face helmet such as 3/4 helmet for illustration purposes.

The main body 101 has multiple connection sections 103 respectively disposed on two opposite sides of the main body 101. The connection sections 103 are detachably connected with the helmet 200. In this embodiment, the connection sections 103 are, but not limited to, two button structures disposed on two opposite inner sides of the main body 101 for illustration purposes. In practice, there can be more than two connection sections 103 and the connection sections 103 can be alternatively tenon/mortise structures or screw structures.

The helmet 200 has the visor 201 and multiple connected sections 203 corresponding to the connection sections 103 of the chin guard 100. The connected sections 203 are detachably connected with the connection sections 103 of the chin guard 100. In this embodiment, the visor 201 is a transparent visor for illustration purposes. The connected sections 203 are, but not limited to, two button structures corresponding to the connection sections 103 for illustration purposes. In practice, the number of the connected sections 203 is equal to the number of the connection sections 103 and the connected sections 203 can be alternatively tenon/mortise structures or screw structures.

The mini projection unit 105 is disposed on one side of the main body 101. The mini projection unit 105 serves to receive and project video information onto the visor 201. In this embodiment, the mini projection unit 105 is a mini projector and the video information is navigation information for illustration purposes. In practice, the video information can be any other information such as weather information or reminder information.

The control unit 107 is disposed in the main body 101 and connected to the mini projection unit 105. The control unit 107 serves to output and transmit the video information to the mini projection unit 105. In this embodiment, the control unit 107 is a microcontroller unit (MCU) for illustration purposes. In practice, the control unit 107 can be alternatively a central processing unit (CPU).

To speak more specifically, when a rider uses the chin guard 100 of the present invention, the connection sections 103 (such as the stud parts of the snap buttons) of the chin guard 100 are connected with the connected sections 203 (such as the socket parts of the snap buttons) of the helmet 200. In this case, the chin guard 100 is connected with the 3/4 helmet 200 to form a full-face helmet. Accordingly, when the rider wears the helmet 200, the rider can observe the ambient environment through the visor 201. In addition, when the rider rides the motorcycle, the control unit 107 can transmit the video information (such as the navigation information) to the mini projection unit 105. The mini projection unit 105 projects the navigation information onto the visor 201 for the rider to watch. Under such circumstance, when riding the motorcycle, the rider will not be distracted by the problem of operation of the navigation device as usual. Therefore, the present invention can effectively promote the safety in riding.

Moreover, the chin guard 100 further includes at least one sensation unit 109, a positioning unit 110, a wireless transmission unit 111, a pickup unit 113, a speaker unit 115, a distance sensation unit 117, a camera unit 119, a storage unit 121, a wired transmission unit 123, a power supply unit 125, at least one pushbutton 127, at least one display unit 129 and a vibration unit 131. The sensation unit 109 is connected to the control unit 107 and disposed in the main body 101 for generating and transmitting at least one sensation signal to the control unit 107. In this embodiment, the sensation unit 109 is an accelerometer for illustration purposes. In practice, the sensation unit 109 can be alternatively a gyroscope or an electronic compass or any other sensation unit. The sensation signal is an acceleration signal for illustration purposes. In practice, the sensation signal can be alternatively an angular speed signal, a magnetic flux signal or any other sensation signal.

The positioning unit 110 is connected to the control unit 107 and disposed in the main body 101 for generating and transmitting positioning information to the control unit 107. In this embodiment, the positioning unit 110 is a global positioning system (GPS) and the positioning information is a geographic coordinate for illustration purposes. When the rider rides the motorcycle, the control unit 107 processes the positioning information and the sensation signal to generate and transmit navigation information to the mini projection unit 105. Accordingly, the mini projection unit 105 can project the navigation information onto the visor 201 of the helmet 200. Under such circumstance, when riding the motorcycle, the rider will not be distracted by the problem of operation of the navigation device as usual. Therefore, the present invention can effectively promote the safety in riding.

The wireless transmission unit 111 is connected to the control unit 107 and disposed in the main body 101. The wireless transmission unit 111 is wirelessly correspondingly connected to an external device (not shown). In this embodiment, the wireless transmission unit 111 is a Bluetooth transceiver for illustration purposes. In practice, the wireless transmission unit 111 can be any other wireless transmission unit such as Wi-Fi transceiver or 4G transceiver. The external device is an intelligent mobile device for illustration purposes. In practice, the external device can be alternatively a computer, a notebook, an intelligent helmet or another chin guard.

Furthermore, the pickup unit 113 is connected to the control unit 107 and disposed in the main body 101 in alignment with a user's mouth. The pickup unit 113 serves to receive a first audio signal and transmit the first audio signal to the control unit 107.

In this embodiment, the pickup unit 113 is a microphone and the first audio signal is a voice command for illustration purposes. In practice, the first audio signal can be any other audio signal such as communication voice. When the rider desires to wirelessly connect the chin guard 100 to the external device (such as the intelligent mobile device), the pickup unit 113 receives the voice command input by the rider so as to control the chin guard 100 wirelessly connect with the external device. Also, the external device can actively wirelessly connect with the chin guard 100. The pickup unit 113 receives the voice command (such as accept connection) input by the rider so as to control the chin guard 100 to wirelessly connect with the external device. Accordingly, the rider can use the external device to make some settings to the chin guard 100, such as language, volume, video quality, warning sound, warning vibration or user account number setting, etc.

The speaker unit 115 is connected to the control unit 107 and disposed in the main body 101 in alignment with the user's ear for outputting a second audio signal. In this embodiment, the speaker unit 115 is a speaker and the second audio signal is a communication voice transmitted by the external device for illustration purposes. In practice, the second audio signal can be any other audio signal such as media playing sound, warning sound or reminding sound. When the rider desires to wirelessly connect the chin guard 100 to the external device (such as the intelligent mobile device), the pickup unit 113 receives the voice command input by the rider. According to the received voice command, the control unit 107 controls the wireless transmission unit 111 to wirelessly connect with the external device (such as the intelligent mobile device). After wirelessly connected, in case the intelligent mobile device has an incoming phone call, the rider inputs the first audio signal (such as a voice command of answering the phone) via the pickup unit 113. At this time, according to the received first audio signal, the control unit 107 generates an answering control signal and transmits the answering control signal to the intelligent mobile device via the wireless transmission unit 111. After the intelligent mobile device receives the answering control signal, the phone call is answered. At the same time, according to the received second audio signal, the control unit 107 transmits the second audio signal to the speaker unit 115 (such as the speaker) to play out. In this case, the rider can hear the voice of the caller on the intelligent mobile device to communicate with the caller. Under such circumstance, when riding the motorcycle, the rider will not be distracted by the problem of operation of the intelligent mobile device as usual. Therefore, the present invention can effectively promote the safety in riding. In addition, after the main body 101 is wirelessly connected to the external device, via the wireless transmission unit 111, the rider can receive the media playing sound (the second audio signal) provided by the external device, whereby the control unit 107 can transmit the received second audio signal to the speaker unit 115 to play out. After the rider accepts to wirelessly connect the chin guard 100 of the present invention with an intelligent helmet or another chin guard (not shown), the rider can perform half-duplex voice communication with the intelligent helmet or the other chin guard via the wireless transmission unit 111 of the chin guard 100.

In addition, the distance sensation unit 117 is connected to the control unit 107 and disposed on the front side of the main body 101 for generating and transmitting a distance sensation signal to the control unit 107. In this embodiment, the distance sensation unit 117 is an ultrasonic sensor and the distance sensation signal is a gesture sensation signal for illustration purposes. In practice, the distance sensation signal can be any other distance sensation signal such as a close-in object distance sensation signal. The rider can input a voice command to wirelessly connect the control unit 107 to the external device. Also, the distance sensation unit 117 (such as the ultrasonic sensor) can sense the gesture of the rider (such as waving the hand up and down twice) to generate and transmit the distance sensation signal (such as the gesture sensation signal) to the control unit 107 so as to control the chin guard 100 to wirelessly connect with the external device. Also, the external device can actively wirelessly connect with the chin guard 100. The distance sensation unit 117 (such as the ultrasonic sensor) senses the gesture of the rider (such as waving the hand up and down twice) to generate and transmit the distance sensation signal (such as the gesture sensation signal) to the control unit 107 so as to control the chin guard 100 to wirelessly connect with the external device. Moreover, after the chin guard 100 is wirelessly connected to the external device (such as the intelligent mobile device) via the wireless transmission unit 111, in case there is a phone call dialed to the intelligent mobile device, the distance sensation unit 117 can sense the gesture of the rider to generate and transmit the distance sensation signal (such as the gesture sensation signal) to the control unit 107. According to the received distance sensation signal, the control unit 107 generates another answering control signal and transmits the other answering control signal to the external device via the wireless transmission unit 111. After the external device receives the other answering control signal, the phone call is answered. Under such circumstance, when riding the motorcycle, the rider will not be distracted by the problem of operation of the intelligent mobile device as usual. Therefore, the present invention can effectively promote the safety in riding.

The camera unit 119 is connected to the control unit 107 and disposed on the front side of the main body 101 for capturing environmental video information and transmitting the environmental video information to the control unit 107. In this embodiment, the camera unit 119 is a dashboard camera and the environmental video information is the video recorded by the dashboard camera for illustration purposes. When the rider rides the motorcycle, the camera unit 119 can capture the environmental video information (such as the video recorded by the dashboard camera). In case a traffic accident happens to the rider in the future, the environmental video information can be used as evidence data.

The storage unit 121 is connected to the control unit 107 and disposed in the main body 101 for the control unit 107 to store or access the environmental video information. In this embodiment, the storage unit 121 is a flash memory for illustration purposes. In practice, the storage unit 121 can be any other storage unit such as an electrically-erasable programmable read-only memory (EEPROM) or a memory card. The environmental video information is the video recorded by the dashboard camera for illustration purposes. In practice, the storage unit 121 also can store other video information. The control unit 107 can receive and store the environmental video information (such as the video recorded by the dashboard camera) captured by the camera unit 119 (such as the dashboard camera) into the storage unit 121 (such as the flash memory). In addition, the storage unit 121 can store the sensation signal (such as the acceleration signal or angular speed signal or magnetic flux signal) of at least one sensation unit 109 (such as the accelerometer or gyroscope or electronic compass). In cooperation with the navigation information generated by the positioning signal (such as the geographic coordinate) of the positioning unit 110 (such as the global positioning system), in case a traffic accident happens to the rider in the future, the sensation signal can be combined with the navigation information and the environmental video information and used as evidence data.

In addition, the wired transmission unit 123 is connected to the control unit 107 and disposed on the main body 101 to be wiredly connected to a corresponding external device (not shown). In this embodiment, the wired transmission unit 123 is a micro USB socket for illustration purposes. In practice, the wired transmission unit 123 can be any other wired transmission unit such as a USB type-C socket. When the chin guard 100 is connected to the external device (such as a computer) via the wired transmission unit 123, the rider can transmit the data such as the video recorded by the dashboard camera or the used navigation information to the external device for the external device to store the data.

In addition, the power supply unit 125 is connected to the control unit 107 and disposed in the main body 101 for supplying power to the control unit 107. In this embodiment, the power supply unit 125 is a Li-Ion battery for illustration purposes. In practice, the power supply unit 125 can be any other cell such as a Li-Poly battery or NiMH battery. In this embodiment, it is shown that the power supply unit 125 (such as the Li-Ion battery) only provides power for the control unit 107. However, this is not limited. Alternatively, the power supply unit 125 can be connected to the sensation unit 109, the positioning unit 110, the wireless transmission unit 111, the pickup unit 113, the speaker unit 115, the distance sensation unit 117, the camera unit 119, the storage unit 121, the wired transmission unit 123, the pushbutton 127, the display unit 129 and the vibration unit 131 to supply power for these units.

In addition, the at least one pushbutton 127 is connected to the control unit 107 and disposed on the main body 101 for transmitting at least one set state signal to the control unit 107. In this embodiment, there are two real pushbuttons, (one of which is a power button 1272, while the other of which is an operation button 1274) for illustration purposes. The set state signal transmitted by the power button 1272 is a turn-on/turn-off signal and the set state signal transmitted by the operation button 1274 is a set connection signal for illustration purposes. When the power button 1272 is triggered (such as pressed down) by the rider with the chin guard 100 in a turn-off (or turn-on) state, the power button 1272 generates and transmits a turn-on signal (or a turn-off signal) to the control unit 107 so as to control and turn on (or turn off) the chin guard 100. When the rider wants to wirelessly connect the chin guard 100 to the external device (such as the intelligent mobile device), the rider not only can input the voice command or use the gesture sensation signal to wirelessly connect the control unit 107 to the external device, but also can trigger (such as press down) the operation button 1274 in the turn-on state to generate and transmit the set state signal (such as the set connection signal) to the control unit 107 so as to control the chin guard 100 to wirelessly connect with the external device. Also, the external device can actively wirelessly connect with the chin guard 100. The operation button 1274 is pressed to generate and transmit the set state signal (such as the set connection signal) to the control unit 107 so as to control the chin guard 100 to wirelessly connect with the external device. It should be noted that in practice, the number of the pushbuttons 127 is not limited to two. The number (such as three or more than four) of the pushbuttons 127 can be previously designed according to the required function.

The display unit 129 is connected to the control unit 107 and disposed on the main body 101. The display unit 129 serves to receive a control signal from the control unit 107 to display at least one state information. In this embodiment, the display unit 129 is an indicator lamp (such as a light-emitting diode (LED)) and the state information indicates the turn-on/turn-off state or video recording state of the chin guard 100 for illustration purposes. In practice, the display unit 129 can be preset with corresponding flickering pattern according to the requirements of different states. For example, the display unit 129 (such as the indicator lamp) can flicker for such as five seconds and then extinguish to indicate the turn-on state. The display unit 129 (such as the indicator lamp) can flicker for such as three seconds and then extinguish to indicate the turn-off state. The display unit 129 (such as the indicator lamp) can continuously circularly flicker for one second and then extinguish for ten seconds to indicate the video recording state. When the rider presses the power button 1272 in the turn-off state, a turn-on signal is generated and transmitted to the control unit 107 to set the chin guard 100 into the turn-on state. At the same time, the control unit 107 generates a control signal to control the display unit 129 (such as the indicator lamp) to flicker for such as five seconds and then extinguish. In this case, the rider can know from the state information shown by the indicator lamp that the chin guard 100 is set in the turn-on state. When the rider inputs the first audio signal (such as the voice command) to the pickup unit 113 in the turn-on state and transmits the first audio signal to the control unit 107, according to the voice command, the control unit 107 will control the camera unit 119 to capture the environmental video information (such as the video recorded by the dashboard camera). At the same time, the control unit 107 generates a control signal to control the display unit 129 (such as the indicator lamp) to continuously circularly flicker for one second and then extinguish for ten seconds. In this case, the rider can know from the state information shown by the indicator lamp that the chin guard 100 is set in the video recording state. It should be noted that in practice, the number of the display unit 129 is not limited to one. The number (such as three or more than four) of the display units 129 can be previously designed according to the required function.

In addition, the vibration unit 131 is connected to the control unit 107 and disposed in the main body 101 to co-vibrate with the main body 101. In this embodiment, the vibration unit 131 is a vibrator for illustration purposes. In practice, the vibration unit 131 can be preset with corresponding co-vibration pattern according to the requirements of different states. For example, the vibration unit 131 (such as the vibrator) can short co-vibrate with the main body 101 for such as one second and then stop to indicate the turn-on state. The vibration unit 131 (such as the vibrator) can long co-vibrate with the main body 101 for such as three seconds and then stop to indicate the turn-off state. The vibration unit 131 (such as the vibrator) can short co-vibrate with the main body 101 for such as two seconds and then stop to indicate the video recording state. The rider not only can know the state of the chin guard 100 from the state information shown by the display unit 129, but also can press the power button 1272 in the turn-off state to generate and transmit the turn-on signal to the control unit 107 so as to set the chin guard 100 into the turn-on state. At the same time, the vibration unit 131 (such as the vibrator) short co-vibrates with the main body 101 for such as one second and then stops, whereby the rider can know from the co-vibration pattern that the chin guard 100 is set into the turn-on state. When the rider inputs the first audio signal (such as the voice command) to the pickup unit 113 in the turn-on state and transmits the first audio signal to the control unit 107, according to the voice command, the control unit 107 will control the camera unit 119 to capture the environmental video information (such as the video recorded by the dashboard camera). At the same time, the vibration unit 131 (such as the vibrator) short co-vibrates with the main body 101 for such as two seconds and then stops, whereby the rider can know from the co-vibration pattern that the chin guard 100 is set into the video recording state.

According to the above arrangements, the rider still can use the additional electronic functions without discarding the currently used helmet. Moreover, by means of the electronic functions of the chin guard 100, when riding the motorcycle, it is unnecessary for the rider to be distracted by the operation of the electronic devices such as the intelligent mobile device or the dashboard camera or the navigation device. Therefore, the present invention can enhance the safety in riding. Also, the present invention can reduce the additional environmental burden and lower the riding cost.

The present invention has been described with the above embodiments thereof and it is understood that many changes and modifications in such as the form or layout pattern or practicing step of the above embodiments can be carried out without departing from the scope and the spirit of the invention that is intended to be limited only by the appended claims.

What is claimed is:

1. A helmet chin guard applicable to a helmet with a visor, the chin guard comprising:
a main body, the main body having multiple connection sections respectively disposed on two opposite sides of the main body, the connection sections being detachably connected with the helmet;
a mini projection unit disposed on one side of the main body, the mini projection unit serving to receive and project video information onto the visor; and
a control unit disposed in the main body and connected to the mini projection unit, the control unit serving to output and transmit the video information to the mini projection unit.

2. The helmet chin guard as claimed in claim 1, wherein the helmet has multiple connected sections corresponding to the connection sections, the connected sections being detachably connected with the connection sections.

3. The helmet chin guard as claimed in claim 1, further comprising at least one sensation unit, the sensation unit being connected to the control unit and disposed in the main body for generating and transmitting at least one sensation signal to the control unit.

4. The helmet chin guard as claimed in claim 1, further comprising at least one wireless transmission unit, the wireless transmission unit being connected to the control unit and disposed in the main body for wirelessly connecting to a corresponding external device.

5. The helmet chin guard as claimed in claim 1, further comprising a pickup unit, the pickup unit being connected to the control unit and disposed in the main body in alignment with a user's mouth, the pickup unit serving to receive a first audio signal and transmit the first audio signal to the control unit.

6. The helmet chin guard as claimed in claim 1, further comprising a speaker unit, the speaker unit being connected to the control unit and disposed in the main body in alignment with a user's ear for outputting a second audio signal.

7. The helmet chin guard as claimed in claim 1, further comprising a distance sensation unit, the distance sensation unit being connected to the control unit and disposed on a front side of the main body for generating and transmitting a distance sensation signal to the control unit.

8. The helmet chin guard as claimed in claim 1, further comprising a camera unit, the camera unit being connected to the control unit and disposed on the front side of the main body for capturing environmental video information and transmitting the environmental video information to the control unit.

9. The helmet chin guard as claimed in claim 1, further comprising a storage unit, the storage unit being connected to the control unit and disposed in the main body for the control unit to store or access environmental video information.

10. The helmet chin guard as claimed in claim 1, further comprising a wired transmission unit, the wired transmission unit being connected to the control unit and disposed on the main body to be wiredly connected to a corresponding external device.

11. The helmet chin guard as claimed in claim 1, further comprising a power supply unit, the power supply unit being connected to the control unit and disposed in the main body for supplying power to the control unit.

12. The helmet chin guard as claimed in claim 1, further comprising at least one pushbutton, the pushbutton being connected to the control unit and disposed on the main body for transmitting at least one set state signal to the control unit.

13. The helmet chin guard as claimed in claim 1, further comprising a display unit, the display unit being connected to the control unit and disposed on the main body, the display unit serving to receive a control signal from the control unit to display at least one state information.

14. The helmet chin guard as claimed in claim 1, further comprising a vibration unit, the vibration unit being connected to the control unit and disposed in the main body to co-vibrate with the main body.

15. The helmet chin guard as claimed in claim 1, further comprising a positioning unit, the positioning unit being connected to the control unit and disposed in the main body for generating and transmitting positioning information to the control unit.

16. The helmet chin guard as claimed in claim 4, wherein the external device is selected from a group consisting of a computer, an intelligent mobile device, a notebook, an intelligent helmet and another chin guard.

17. The helmet chin guard as claimed in claim 10, wherein the external device is selected from a group consisting of a computer, an intelligent mobile device, a notebook, an intelligent helmet and another chin guard.
